(19) United States
(12) Patent Application Publication
(10) Pub. No.: US 2014/0176333 A1
(43) Pub. Date: Jun. 26, 2014

(54) INFORMATION PROCESSING APPARATUS, INFORMATION PROCESSING METHOD, AND STORAGE MEDIUM

(71) Applicant: KABUSHIKI KAISHA TOSHIBA, Tokyo (JP)

(72) Inventor: Tadashi Tsuji, Tachikawa-shi (JP)

(73) Assignee: KABUSHIKI KAISHA TOSHIBA, Tokyo (JP)

(21) Appl. No.: 14/018,016

(22) Filed: Sep. 4, 2013

Related U.S. Application Data
(63) Continuation of application No. PCT/JP2013/058621, filed on Mar. 25, 2013.

(30) Foreign Application Priority Data
Dec. 25, 2012 (JP) 2012-281698

(51) Int. Cl. G08B 21/18

(52) U.S. Cl. CPC G08B 21/182
USPC 340/689

(57) ABSTRACT

According to one embodiment, an information processing apparatus includes a main body, a display portion configured to freely open and close with respect to the main body, and a notification module. The notification module is configured to generate a notification when an opening angle of the display portion respect to the main body exceeds a threshold value.

### CROSS-REFERENCE TO RELATED APPLICATIONS

This application is a Continuation Application of PCT Application No. PCT/JP2013/058621, filed Mar. 25, 2013 and based upon and claiming the benefit of priority from Japanese Patent Application No. 2012-281698, filed Dec. 25, 2012, the entire contents of all of which are incorporated herein by reference.

### FIELD

Embodiments described herein relate generally to an information processing apparatus, an information processing method, and a storage medium in which a display portion is configured to freely open and close with respect to a main body.

### BACKGROUND

A conventional example of the information processing apparatus includes a folding mobile phone, a notebook-sized personal computer, and the like. A display portion is rotatably coupled to a main body through a hinge. An upper limit is determined for an opening angle of the display portion due to various structural constraints, and a defect may occur in the main body, the display portion, and the hinge when the display portion is opened at an angle greater than or equal to the upper limit.

In the conventional information processing apparatus, however, a unit for preventing a user from opening the display portion at an angle exceeding the upper limit is absent.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view illustrating an example of an appearance of an information processing apparatus of an embodiment.

FIG. 2 is a cross-sectional view of a hinge of the information processing apparatus of the embodiment.

FIG. 3 is a block diagram illustrating an example of a system configuration of the information processing apparatus of the embodiment.

FIGS. 4A, 4B, and 4C are diagrams illustrating an example of a setting menu of the information processing apparatus of the embodiment.

FIG. 5A is a flowchart illustrating an example of a flow of processing of the information processing apparatus of the embodiment.

FIG. 5B is a flowchart illustrating an example of a flow of processing of the information processing apparatus of the embodiment.

FIGS. 6A, 6B, and 6C are perspective views illustrating an example of an appearance of an information processing apparatus of a second embodiment.

FIG. 7 is a flowchart illustrating an example of a flow of processing of the information processing apparatus of the second embodiment.

### DETAILED DESCRIPTION

Various embodiments will be described hereinafter with reference to the accompanying drawings.

In general, according to one embodiment, an information processing apparatus includes a main body, a display portion configured to freely open and close with respect to the main body, and a notification module. The notification module is configured to generate a notification when an opening angle of the display portion respect to the main body exceeds a threshold value.

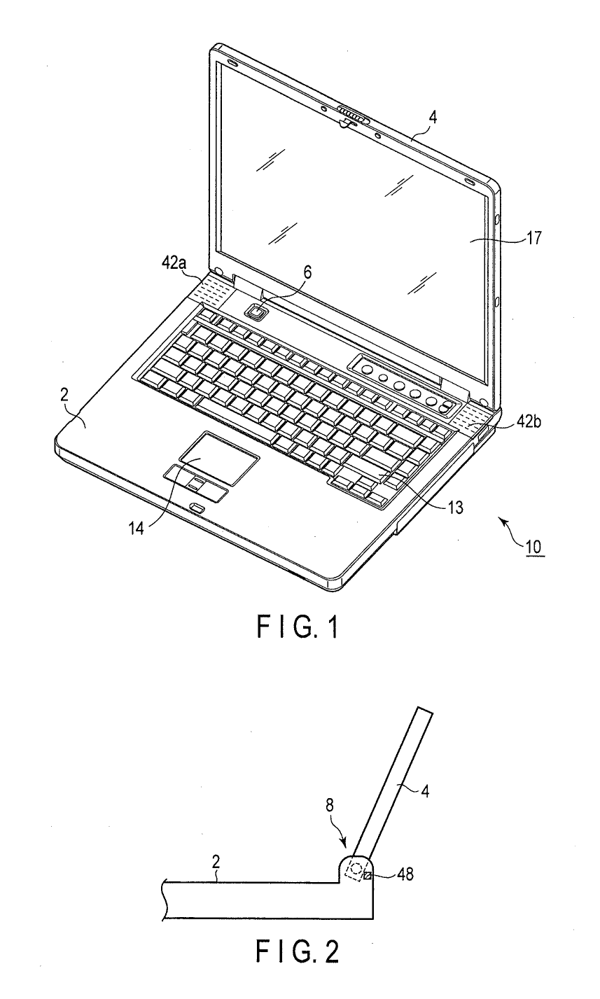

FIG. 1 is a perspective view illustrating an example of an appearance of an information processing apparatus of an embodiment. For example, the information processing apparatus is implemented as a notebook-sized personal computer 10. The computer 10 includes a computer main body 2 and a display unit 4. A touch screen display 17 including an LCD (Liquid Crystal Display) 17a and a touch panel 17b is incorporated in the display unit 4. However, the touch panel 17b is not necessarily provided, and the display unit 4 may comprise a normal LCD (Liquid Crystal Display) 17a.

The display unit 4 is attached to the computer main body 2 through a hinge 8 to freely rotate between an opened position in which an upper surface of the computer main body 2 is exposed and a closed position in which the upper surface of the computer main body 2 is covered. An upper limit is determined for the opened position. For example, the display unit should not be opened at 120° or more (the closed state is set to 0°). When a force is applied to open the display unit 4 at 120° or more, a defect may occur in the display unit 4, the computer main body 2, and/or the hinge 8.

In the embodiment, when a pressure applied to the hinge 8 is detected, and the detected pressure is greater than or equal to a certain value, the information is notified to a user such that the user stops opening the display unit 4 at an angle corresponding to the certain value. For this reason, as a cross-sectional structure is illustrated in FIG. 2, a pressure sensor 48 is attached to a place inside of the hinge 8 touched by the display unit 4 when the display unit 4 is opened at an angle slightly smaller than an upper limit angle (for example, 115°). The pressure sensor 48 does not detect a pressure when the display unit 4 is not in a contact state, and detects a pressure by a contact of the display unit 4 when the display unit 4 is to be opened at an angle exceeding the upper limit angle.

A disposition and a structure of the pressure sensor 48 are not limited thereto, and a pressure sensor having a different structure may be provided in another place. In short, when the display unit 4 is opened at an angle exceeding the upper limit angle, a portion of the display unit 4 is in a contact state, and a pressure thereof may be detected. For example, rather than a configuration for detecting a pressure as a binary level, another configuration may be employed to detect a pressure that gradually changes in response to an opening angle when the display unit 4 is at an angle near the upper limit angle. In either case, a configuration may be employed to detect that the display unit 4 is opened at an angle reaching the upper limit angle when a detected pressure is greater than or equal to a certain threshold value.

The computer main body 2 includes a casing in a shape of a thin box, and a keyboard 13, a power button 6 for turning ON and turning OFF the computer 10, a touch pad 14, speakers 42a and 42b, and the like are disposed on an upper surface thereof. The computer 10 is activated when the power button 6 is turned ON by a user. The activated computer 10 is operated in accordance with an input signal from an input interface such as the keyboard 13 or the touch pad 14 by an operation of a user. In addition, the computer 10 displays information on the LCD 17a in accordance with the input signal.

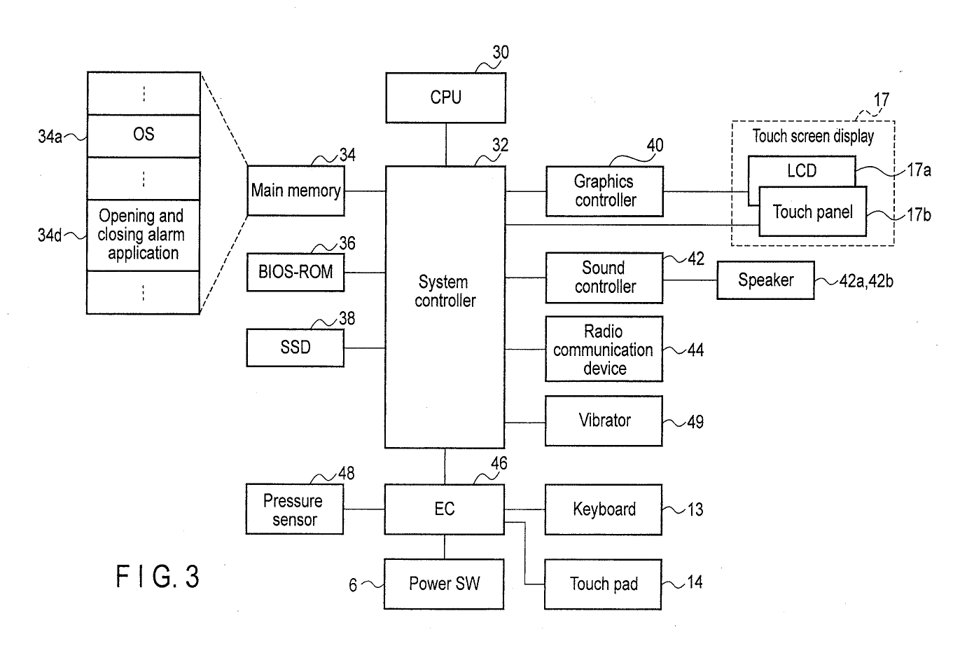

FIG. 3 illustrates a system configuration of the computer 10. The computer 10 includes a CPU 30, a system controller 32, a main memory 34, a BIOS-ROM 36, an SSD (Solid State Drive) 38, a graphics controller 40, a sound controller 42, a wireless communication device 44, a vibrator 49, an embedded controller 46, and the like.

The CPU 30 is a processor that controls an operation of various modules mounted on the computer 10. The CPU 30 executes various types of software loaded on the main memory 34 from the SSD 38 which is a non-volatile storage device. The software includes an operating system (OS) 34a, an opening and closing alarm application program 34d, and the like.

When an opening angle of the display unit 4 with respect to the computer main body 2 exceeds the upper limit, the opening and closing alarm application program 34d generates an alarm to notify a user of the information. Whether the angle exceeds the upper limit is detected based on a pressure applied to the hinge 8.

The CPU 30 further executes a basic input/output system (BIOS) stored in the BIOS-ROM 36. The BIOS is a program for controlling hardware.

The system controller 32 is a device that connects the CPU 30 and various components to each other. A memory controller controlling access of the main memory 34 is incorporated in the system controller 32. The main memory 34, the BIOS-ROM 36, the SSD 38, the graphics controller 40, the sound controller 42, the wireless communication device 44, the embedded controller 46, the vibrator 49, and the like are connected to the system controller 32. When an opening angle of the display unit 4 exceeds the upper limit, the vibrator 49 vibrates and generates an alarm under a control of the opening and closing alarm application program 34d.

The graphics controller 40 controls the LCD 17a used as a display monitor of the personal computer 10. The graphics controller 40 transmits a display signal to the LCD 17a under a control of the CPU 30. The LCD 17a displays a screen image based on a display signal. When an opening angle of the display unit 4 exceeds the upper limit, the LCD 17a displays an alarm text and generates an alarm under a control of the opening and closing alarm application program 34d. The touch panel 17b is disposed on a display surface of the LCD 17a. For example, the touch panel 17b is a capacitive sensor for performing an input on a screen of the LCD 17a.

The sound controller 42 is a controller for processing a sound signal, and controls an audio output by the speakers 42a and 42b. When an opening angle of the display unit 4 exceeds the upper limit, the sound controller 42 generates a predetermined sound, for example, a beep sound, and generates an alarm under a control of the opening and closing alarm application program 34d.

The wireless communication device 44 is a device configured to execute wireless communication such as a wireless LAN and 3G mobile communication, or proximity wireless communication such as NFC (Near Field Communication).

The embedded controller 46 is a one-chip microcomputer including a controller for power management. The embedded controller 46 has a function of turning ON or turning OFF the computer 10 in response to an operation of a power button by a user. In addition, the embedded controller 46 controls an input of the keyboard 20 and the touch pad 22. An output of the pressure sensor 48 provided in the hinge 8 is input to the embedded controller 46.

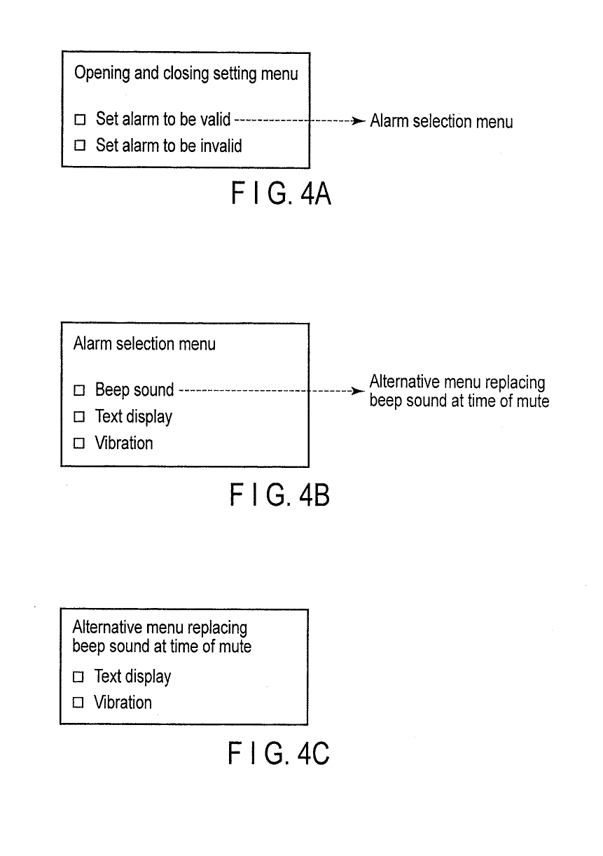

Subsequently, an opening and closing alarm of the embodiment is described. The opening and closing alarm application program 34d may be selectively set be invalid by a setting of a user. For example, in a case of a mobile phone, the phone may be unconsciously brought close to an ear when a call volume is small. In this case, an alarm may not be intended to be generated even when the phone is opened to slightly exceed an upper limit within a range of a slight play. For this reason, as illustrated in FIG. 4A, the OS 34a may display a menu capable of designating a valid/invalid state of the opening and closing alarm application program 34d. The menu may be opened from a main menu. As illustrated in FIG. 4B, when an alarm is set to be valid, an alarm selection menu is displayed. A type of alarm may be arbitrarily selected from a sound (beep sound is set by default), a text display, and a vibration. A plurality of types may be selected in addition to a type. In general, the alarm is the sound (beep sound). However, as described in the foregoing, in a case of a mobile phone, an opening angle may unconsciously exceed a threshold value during a voice call, it may not be preferable that the beep sound is generated during a voice call, and the vibration may be preferable. Alternatively, in a case of a notebook PC, displaying an alarm message may be preferable. Although not illustrated, the beep sound is set by default as the sound. However, the invention is not limited thereto, and a type of sound may be freely set. Further, when a sound is selected as an alarm, and the computer 10 is set to mute, the computer does not sound and thus, does not function as an alarm. Thus, as illustrated in FIG. 4C, a type of alternative alarm at the time of mute may be selected from a text display and a vibration, and an alarm sound is automatically replaced by another alarm at the time of mute.

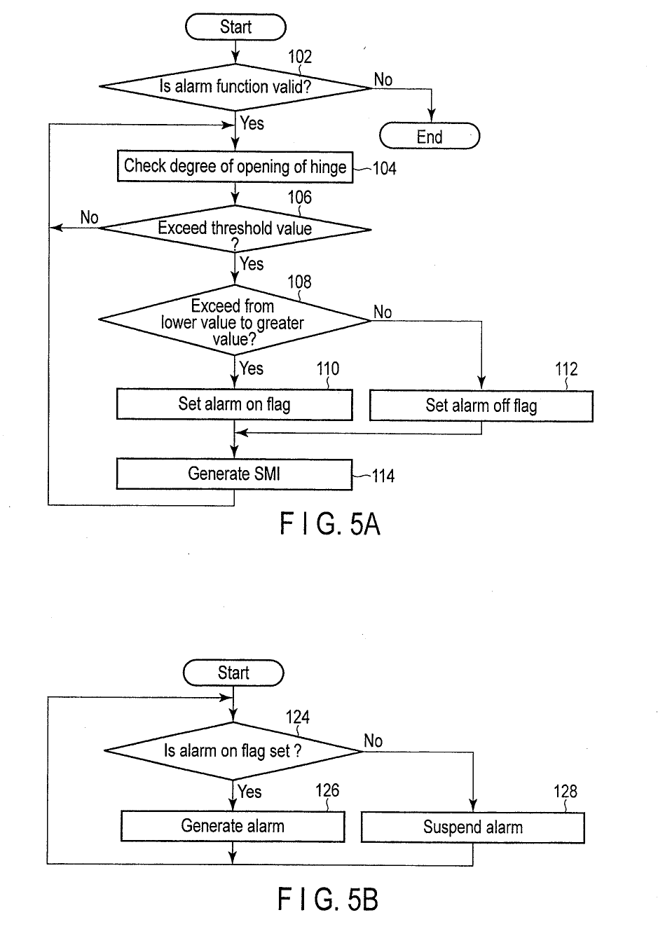

FIGS. 5A and 5B are flowcharts illustrating a flow of processing of the opening and closing alarm application program 34d. FIG. 5A is processing by the embedded controller 46, and FIG. 5B is processing by the BIOS.

As illustrated in the foregoing, the opening and closing alarm application program 34d may be selectively invalid by a setting of a user. For this reason, it is determined whether an alarm function by the opening and closing alarm application program 34d is valid or invalid in block 102. When the alarm function is set to be invalid, the opening and closing alarm application program 34d is terminated. The embedded controller 46 starts the processing of FIG. 5A at fixed intervals during an operation of the device.

When the alarm function is set to be valid, an opening angle of the display unit 4 with respect to the computer main body 2, that is, a degree of opening of the hinge 8 is checked in block 104. The degree of opening of the hinge 8 may be checked by a pressure detected by the pressure sensor 48 which is attached to the hinge 8. When the opening angle of the display unit 4 exceeds the upper limit, a load pressure applied to the hinge is greater than or equal to a predetermined threshold value. Thus, it is possible to detect that the hinge 8 is to be operated beyond a range of motion by a change of pressure.

In block 106, it is determined whether a detection result of the pressure sensor 48 exceeds the threshold value. When the detection result exceeds the threshold value, it is determined whether the detection result changes from a value less than the threshold value to a value greater than the threshold value in block 108.

When the detection result changes from a value less than the threshold value to a value greater than the threshold value, an alarm ON flag is set in block 110. When a state in which the detection result is greater than the threshold value is continued, there is a concern that a defect occurs in the display unit 4, the computer main body 2, and/or the hinge 8, and an alarm is generated to attract attention of a user.

When the detection result changes from a value greater than the threshold value to a value less than the threshold value, an alarm OFF flag is set in block 112. When the detection result changes from a value greater than the threshold value to a value less than the threshold value, a defect occurring in the display unit 4, the computer main body 2, and/or the hinge 8 is solved, and generating of an alarm may be suspended.

An SMI (system management interrupt) is generated in block 114 subsequent to blocks 110 and 112, and the operation returns to block 104.

As illustrated in FIG. 5B, the BIOS determines whether the alarm ON flag is set, that is, whether the detection result changes from a value less than the threshold value to a value greater than the threshold value in block 124.

When the alarm ON flag is set, an alarm is generated in block 126. When the alarm ON flag is not set, an alarm is suspended in block 128. The BIOS executes block 124 after blocks 126 and 128.

As described in the foregoing, in accordance with the first embodiment, an opening angle of a hinge is detected such that an alarm is generated when the opening angle exceeds a predetermined angle, and an alarm is suspended when the opening angle returns to a value less than or equal to the predetermined angle. In this way, a user determines that the user needs to perform an operation such that the display unit 4 is closed when an alarm is generated, and it is possible to prevent the display unit 4 from being excessively opened and prevent a detect from occurring in the display unit 4, the computer main body 2, and/or the hinge 8. An alarm may be arbitrarily selected from a sound, a text display, and a vibration, and it is possible to select an alarm convenient for a user. Since an ON/OFF of an alarm function may be selected, it is possible to turn OFF an alarm function depending on a situation.

Hereinafter, another embodiment is described. In a description of the other embodiment, the same portion as that of the first embodiment is denoted by the same reference number, and a detailed description thereof is omitted.

### Second embodiment

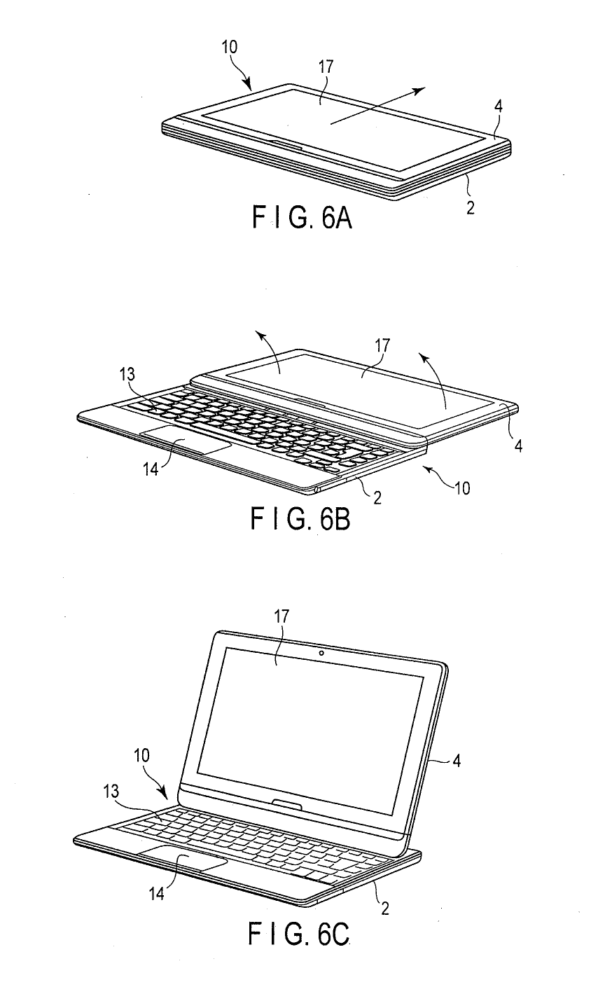

In the first embodiment, a folding notebook PC is described and thus, only the upper limit corresponds to a limit of a range of motion of the display unit 4 in opening direction. In the second embodiment, a convertible computer 10 that may be converted to a notebook mode and a tablet mode as illustrated in FIGS. 6A to 6C is described. FIG. 6A is a perspective view illustrating an appearance in a case of the tablet mode. A computer main body 2 (identical to the computer main body 2 of FIG. 1) and a display unit 4 overlap each other in a state in which a touch screen display 17 faces outward. The display unit 4 slides along a short side as illustrated by an arrow of FIG. 6A from the state, and is displaced to a state in which a keyboard 13 is exposed as illustrated in FIG. 6B. Although not illustrated, a groove is formed in a direction along the short side on a rear surface of the display unit 4, and a projection that engages with the groove is formed on the computer main body 2. Further, although not illustrated, a hinge is received in the rear surface of the display unit 4. In a state of FIG. 6B, the hinge protrudes from the rear surface to cause the computer main body 2 and the display unit 4 to engage with each other. In the second embodiment, a touch screen display 17 including an LCD (Liquid Crystal Display) 17a and a touch panel 17b is needed to be incorporated in the display unit 4.

The state of FIG. 6B is a state in which a mode is being converted. When the display unit 4 is inclined toward a front side as illustrated by an arrow of FIG. 6B from the state, a mode is converted to the notebook mode as illustrated in FIG. 6C. FIG. 6C is the same state as that of FIG. 1. In the second embodiment, the display unit 4 is opened and closed from a state of an opening angle=0° illustrated in FIG. 6B to a maximum opening angle illustrated in FIG. 6C. When a force is applied to the display unit 4 toward a back side which is opposite to the arrow of FIG. 6B in the state of FIG. 6B, a defect may occur in the display unit 4, the computer main body 2, and/or the hinge 8. Similarly to the first embodiment, when a force is applied to further incline the display unit 4 toward a front side in the state of FIG. 6C, a defect may occur in the display unit 4, the computer main body 2, and/or the hinge 8. In the second embodiment, two angles of a maximum angle and a minimum angle correspond to a limit of a range of motion of the hinge (or the display unit 4).

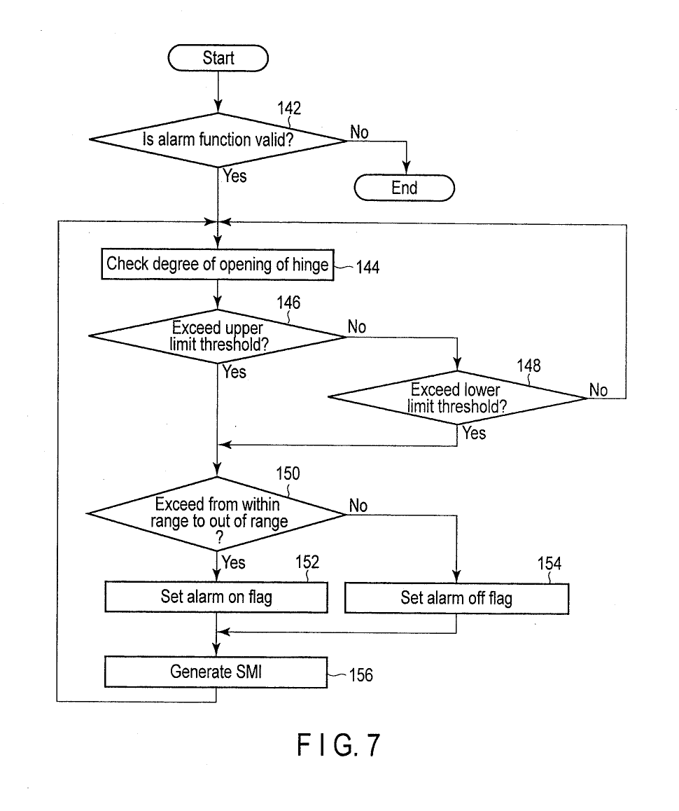

FIG. 7 is a flowchart illustrating a flow of processing by an embedded controller 46 which is comprised in processing by an opening and closing alarm application program 34d. Processing by the BIOS is the same as that of the first embodiment.

In block 142, it is determined whether an alarm function by the opening and closing alarm application program 34d is valid or invalid. When the alarm function is set to be invalid, the opening and closing alarm application program 34d is terminated. The embedded controller 46 starts the processing of FIG. 7 at fixed intervals during an operation of the device.

When the alarm function is set to be valid, an opening angle of the display unit 4 with respect to the computer main body 2, that is, a degree of opening of the hinge 8 is checked in block 144.

In block 146, it is determined whether a detection result of the pressure sensor 48 exceeds an upper limit threshold of a range of movement (FIG. 6C). When the detection result does not exceed the upper limit threshold, it is determined whether the detection result of the pressure sensor 48 exceeds a lower limit threshold of a range of movement (FIG. 6B) in block 148. When the detection result exceeds the lower limit threshold, the operation returns to block 144.

In a case of yes (exceeding the upper limit threshold or the lower limit threshold) in blocks 146 and 148, it is determined whether the detection result changes from within the range of movement to out of the range of movement in block 150. When the detection result changes from within the range of movement to out of the range of movement, an alarm ON flag is set in block 152. In a case of changing from out of the range of movement to within the range of movement, an alarm OFF flag is set in block 154.

As illustrated in the foregoing, in accordance with the second embodiment, an alarm is generated in response to an opening angle of the hinge being out of the range of movement, and a generation of the alarm is suspended in response to the angle returning to within the range of movement. A similar effect to that of the first embodiment is provided.

A procedure of operation control processing of the embodiment may be implemented by a computer program. Thus, it is possible to easily achieve a similar effect to that of the embodiment by merely installing and executing the computer program in a normal convertible computer through a computer-readable storage medium storing the computer program.

Further, the invention is not limited to the embodiments described above without change, and may be implemented by changing a component within a scope in an implementation phase. Further, various inventions may be conceived by appropriately combining a plurality of components disclosed in the embodiments described above. For example, several components may be removed from the entire components disclosed in the embodiments. Furthermore, a component for different embodiments may be appropriately combined. For example, even though a degree of opening of the display unit 4 is detected using the pressure sensor, a sensor that directly quantifies an opening angle of the display unit 4 may be used. In addition, an applied product is not limited to the product described above, and any product may be applied as long as a display portion is configured to freely open and close with respect to a main body.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body;
a display portion configured to freely open and close with respect to the main body; and
a notification module configured to generate a notification when an opening angle of the display portion respect to the main body exceeds a threshold value.

2. The information processing apparatus of claim 1, wherein the notification module comprises:
a sensor configured to detect a pressure applied to a hinge between the main body and the display portion; and
a detector configured to detect that a pressure detected by the sensor exceeds a predetermined pressure.

3. The information processing apparatus of claim 1, wherein the notification module comprises:
a sensor configured to detect an angle of the display portion with respect to the main body; and
a detector configured to detect that an angle detected by the sensor exceeds a predetermined angle.

4. The information processing apparatus of claim 1,
wherein the notification module is configured to generate a notification when an opening angle of the display portion with respect to the main body is out of a predetermined range.

5. The information processing apparatus of claim 1,
wherein the notification module comprises at least one of a generator of an alarm sound, a display of an alarm message, and a vibration unit.

6. The information processing apparatus of claim 1,
wherein the notification module is configured to suspend a generation of the notification when an opening angle of the display portion with respect to the main body is less than or equal to a threshold value.

7. The information processing apparatus of claim 1, further comprising:
a setting module configured to set an operation of the notification module to be valid or invalid.

8. An information processing method of an information processing apparatus which comprises a main body and a display portion configured to freely open and close with respect to the main body, the method comprising:
generating a notification an opening angle of the display portion respect to the main body exceeds a threshold value.

9. The information processing method of claim 8, further comprising:
detecting a pressure applied to a hinge between the main body and the display portion; and
detecting that the detected pressure exceeds a predetermined pressure.

10. The information processing method of claim 8, further comprising:
detecting an angle of the display portion with respect to the main body; and
detecting that the detected angle exceeds a predetermined angle.

11. The information processing method of claim 8,
wherein the notification is generated when an opening angle of the display portion with respect to the main body is out of a predetermined range.

12. The information processing method of claim 8,
wherein the notification comprises at least one of a sound, a message, and a vibration.

13. The information processing method of claim 8, further comprising:
suspending a generation of the notification when an opening angle of the display portion with respect to the main body is less than or equal to a threshold value.

14. The information processing method of claim 8, further comprising
setting the generating to be valid or invalid.

15. A non-transitory computer-readable storage medium having stored thereon a computer program which is executable by a computer which comprises a main body and a display portion configured to freely open and close with respect to the main body, the computer program comprising instructions capable of causing the computer to execute functions of:
generating a notification an opening angle of the display portion respect to the main body exceeds a threshold value.

16. The storage medium of claim 15, further comprising:
detecting a pressure applied to a hinge between the main body and the display portion; and
detecting that the detected pressure exceeds a predetermined pressure.

17. The storage medium of claim 15, further comprising:
detecting an angle of the display portion with respect to the main body; and
detecting that the detected angle exceeds a predetermined angle.

18. The storage medium of claim 15,
wherein the notification is generated when an opening angle of the display portion with respect to the main body is out of a predetermined range.

19. The storage medium of claim 15,
wherein the notification comprises at least one of a sound, a message, and a vibration.

20. The storage medium of claim 15, further comprising:
suspending a generation of the notification when an opening angle of the display portion with respect to the main body is less than or equal to a threshold value.
